(19) United States
(12) Patent Application Publication
(10) Pub. No.: US 2026/0342078 A1
(43) Pub. Date: Oct. 29, 2026

(54) Surge Protection System and Method for Operating a Surge Protection System

(71) Applicant: DEHN SE, Neumarkt i.d.OPf. (DE)

(72) Inventors: Thomas Böhm, Hohenfels (DE); Uwe Strangfeld, Nürnberg (DE); Better Li, Shanghai (CN); Jack Xu, Shanghai (CN); Kaster Luo, Shanghai (CN); Lino Ren, Shanghai (CN); Jon Zhang, Shanghai (CN)

(21) Appl. No.: 19/650,535

(22) Filed: Apr. 17, 2026

(30) Foreign Application Priority Data
Apr. 24, 2025 (DE) 10 2025 115 888.6

(51) Int. Cl. H02H 9/00; H02H 9/02

(52) U.S. Cl. CPC H02H 9/005; H02H 9/02

(57) ABSTRACT

Embodiments of the present disclosure relate to a surge protection system comprising a surge protection module having a surge protection functionality, and a disconnecting module connected in series with the surge protection module. The disconnecting module is capable of carrying impulse currents and at least limits mains follow currents. Furthermore, the disconnecting module has a voltage sustaining capability. The surge protection system has a tripping circuit arranged in parallel with the disconnecting module such that, in the event of a defect in the surge protection module, there is a current path via the tripping circuit and the surge protection module. The tripping circuit comprises a tripping element and a current limiting unit which limits a current flowing through the tripping element in the event of a defect in the surge protection module. The tripping element is set up to trip in the event of a defect in the surge protection module and to activate an output which signals the event of defect in the surge protection module. Furthermore, a method for operating a surge protection system is described.

### TECHNICAL FIELD

Embodiments of the present disclosure relate to a surge protection system. Further embodiments of the present disclosure relate to a method for operating a surge protection system.

### BACKGROUND

Surge protection systems typically employ surge protection modules for surge protection, which are known from the prior art and are used in a wide variety of applications. A primary application area for surge protection, in which such surge protection modules are used, is at electrical energy feed-in points in buildings or in branched power distribution systems.

The surge protection modules are used, for example, in separately designed surge protection devices (SPD). The surge protection modules generally function such that, in the event of a transient or temporary overvoltage, they become low-impedance to dissipate the energy of a surge impulse. Overload and operating conditions outside the specified rated data of the surge protection modules may result in failure of the surge protection modules.

Typically, the defect of a surge protection module results in a permanent low-impedance behavior, causing upstream protective elements (“Over Current Protection” OCP) such as fuses or miniature circuit breakers (“MCB”) to trip. To prevent a complete voltage breakdown due to overcurrent shutdown in the energy distribution system, additional (pre-)fuses are arranged downstream of the branch to the surge protection module, if necessary.

However, dimensioning these (pre-)fuses is complicated as two criteria must be met, which make correct dimensioning difficult. On the one hand, the (pre-)fuses must not be dimensioned too small so that surge currents or lightning surge currents, also known as current impulses, do not cause tripping, and on the other hand, the respective (pre-)fuses must not be dimensioned too large to prevent the destruction of a defective surge protection module due to high thermal stress. In principle, such (pre-)fuses are provided to trip at currents in the kiloampere range.

Furthermore, it is known from the prior art that the surge protection device has an integrated fuse which trips when a short circuit occurs to disconnect the surge protection device from the mains.

There is a need to detect such a defect in the surge protection module in a simple manner and to safely disconnect the latter in the event of a fault.

### SUMMARY

According to the present disclosure, the need is satisfied by a surge protection system comprising a surge protection module having a surge protection functionality, and a disconnecting module connected in series with the surge protection module. The disconnecting module is capable of carrying impulse currents and at least limits mains follow currents. In addition, the disconnecting module has a voltage sustaining capability. The surge protection system comprises a tripping circuit arranged in parallel with the disconnecting module such that, in the event of a defect in the surge protection module, there is a current path via the tripping circuit and the surge protection module. The tripping circuit comprises a tripping element and a current-limiting unit which limits a current flowing through the tripping element in the event of a defect in the surge protection module. The tripping element is set up to trip in the event of a defect in the surge protection module and to activate an output, in particular an indicator, which signals or indicates the event of a defect in the surge protection module.

According to the present disclosure, the need is furthermore satisfied by a method for operating a surge protection system comprising a surge protection module having a surge protection functionality, a disconnecting module which is capable of carrying impulse currents and at least limits mains follow currents, and has a voltage sustaining capability. The disconnecting module is connected in series with the surge protection module. When the surge protection module is intact, a surge current or lightning surge current is discharged via the disconnecting module and the surge protection module. The surge protection system comprises a tripping circuit arranged in parallel with the disconnecting module such that, in the event of a defect in the surge protection module, there is a current path via the tripping circuit and the surge protection module, so that, in the event of a defective surge protection module, a current flows through the current path, which trips a tripping element of the tripping circuit, thereby activating an output, in particular, an indicator which signals or indicates the event of a defect in the surge protection module.

The basic idea of the present disclosure is to connect the disconnecting module in series with the surge protection module, in particular upstream thereof, and at the same time to arrange the tripping circuit in parallel with the disconnecting module such that there is a current path via the tripping circuit and the surge protection module when the surge protection module is defective. If the surge protection module is defective and thus permanently in a low-impedance state, a current flows through the current path in which the tripping circuit is arranged. This is ultimately because the tripping circuit is connected to the mains when the surge protection module has become low-impedance. The tripping element of the tripping circuit is then traversed accordingly by the current and dimensioned so as to trip, in particular after a certain duration of current flow, e.g., after a few milliseconds. The tripping of the tripping element results in an output, specifically an indicator, being activated, which signals or indicates the event of a defect in the surge protection module.

In this respect, a user is informed that the surge protection module is defective. The voltage sustaining capability of the surge protection system is still ensured, as the disconnecting module connected in series with the surge protection module has a voltage sustaining capability.

In addition, the disconnecting module may disconnect the defective surge protection module from the mains, thus protecting the defective surge protection module from irreparable damage.

In particular, the disconnecting module includes a spark gap, such as a horn gap. It is thus ensured that the disconnecting module has an inherent voltage sustaining capability.

Furthermore, the disconnecting module may have a longer service life than the surge protection module. This ensures that the disconnecting module remains intact in the event of a defect in the surge protection module and can take over the surge protection functionality.

In particular, a mains follow current from the surge protection module and/or the disconnecting module is at least limited. Furthermore, the surge protection module and/or the disconnecting module may be set up to quench a mains follow current.

The event of a defect in the surge protection module includes age-related degradation of the surge protection module as well as degradation due to overloading. In this respect, the event of a defect in the surge protection module corresponds to a degradation of the surge protection module, in particular a degradation resulting in a short circuit of the surge protection module. The event of a defect in the surge protection module thus results in a short-circuit current flowing, since the surge protection module has become low-impedance due to the defect.

Due to the event of a defect in the surge protection module, both the disconnecting module and the tripping circuit remain (permanently) connected to the mains, causing the current to flow through the tripping circuit, as a result of which the tripping element of the tripping circuit trips and activates the output, specifically the indicator, accordingly.

The disconnecting module has short-circuit current extinguishing capability, i.e., any short-circuit current can be extinguished by the disconnecting module. Consequently, the surge protection system remains capable of extinguishing short-circuit currents even in the event of a defect in the surge protection module.

In particular, the disconnecting module has an (intrinsic) voltage sustaining capability, which is, for example, 6 kV. In other words, the disconnecting module is designed such that a current associated with a surge voltage above, for example, 6 kV, in particular a lightning surge voltage, can be discharged even if the surge protection module is defective. In other words, when a voltage of at least, for example, 6 kV is applied, current flows across the disconnecting module. The current flow can be limited, in particular also be extinguished by the disconnecting module.

In principle, the output may be a visual output, i.e., an indicator. Alternatively or additionally, however, the output may also be provided acoustically, electrically, or electromagnetically.

One aspect provides that the tripping element is set up to mechanically activate the output, in particular the indicator, specifically by means of a mechanical impulse. The indicator may be a red-green indicator that is mechanically adjustable, for example, to transition from an initial state in which the indicator shows “green” to a tripping state in which the indicator shows “red.” The red-green indicator may comprise an indicator element having two areas which include a red signal color and a green signal color. Depending on the state of the surge protection system, in particular the surge protection module, one of the two areas is visible, i.e., either the area with the green signal color or the area with the red signal color. The indicator element can thus be adjusted between two different positions by the tripping element, only one of the two areas being visible in both positions. For example, a viewing window is associated with the indicator element so that, in the initial state, the area with the green signal color is visible through the viewing window, whereas in the event of a defect in the surge protection module, the area with the red signal color is visible through the viewing window.

When the tripping element is tripped, a mechanical impulse may therefore be generated, which is used to mechanically adjust the mechanical indicator so that the event of a defect in the surge protection module is indicated.

Alternatively, the mechanical impulse can be used to drive an electrical indicator to indicate the event of a defect in the surge protection module.

In principle, however, the indicator may also be electrically driven when the tripping element trips. This is particularly the case when the indicator is a display or similar device.

The output, which may be set up as an acoustic, electrical, and/or electromagnetic output, may also be electrically driven to signal the event of a defect in the surge protection module acoustically, electrically, and/or electromagnetically.

A further aspect provides that the tripping element is also set up to actuate a functional component, in particular a disconnecting device and/or a telecommunication unit. The mechanical impulse generated when the tripping element trips may (additionally) be used to actuate a downstream functional component, e.g., to trip a disconnecting device, so that the surge protection module is safely disconnected when the tripping element has tripped. A telecommunication unit may also be activated, for example by disconnecting a telecommunication contact when the tripping element trips, in particular due to the mechanical impulse.

In particular, the tripping circuit and the disconnecting module arranged in parallel with the tripping circuit are dimensioned such that the disconnecting module and the surge protection module discharge a surge current, in particular a lightning surge current, during a discharge process and/or only a negligible portion of the surge current or lightning surge current flows across the tripping element, i.e., the latter does not trip during a (regular) discharge process of the surge current or lightning surge current by means of the surge protection module. The surge protection module, provided it is intact, is capable of discharging the surge current or lightning surge current and at least limiting or extinguishing a mains follow current. The tripping circuit is dimensioned such that the tripping element thereof does not trip during regular operation of the surge protection module, as the surge current, particularly the lightning surge current, is discharged via the disconnecting module and the surge protection module. This is because the surge current or lightning surge current is only of short duration during a discharge process in regular operation.

The tripping circuit is dimensioned with respect to its characteristics/characteristic curve such that the tripping element is not stressed during the discharge of the surge current or lightning surge current, so that the tripping element does not trip.

If, on the other hand, the surge protection module is defective, the surge protection module becomes permanently low-impedance. In this case, the disconnecting module takes over the protection of the surge protection module, in particular by limiting or extinguishing the mains follow current. Since the tripping circuit is arranged in parallel with the disconnecting module, the tripping circuit and the disconnecting module are connected to the mains in the event of a defect in the surge protection module, so that a current flows through the tripping element, which is limited due to the resistance of the tripping circuit. The current flowing through the tripping element in the event of a defect in the surge protection module causes the tripping element to trip, thereby driving the output, in particular the indicator, to signal or indicate the event of a defect in the surge protection module.

The current limiting unit may limit the current flowing through the tripping element to less than 50 A, in particular to less than 10 A. Alternatively or additionally, the tripping element may have a tripping characteristic curve which ensures that the tripping element trips at a current of less than 50 A, in particular at a current of less than 10 A. These parameters ensure reliable defect detection.

The current limiting unit ensures that only a low current flows through the tripping element, particularly in comparison to pre-fuses known from the prior art, which must conduct the surge current or lightning surge current without tripping. A 250 A pre-fuse used in the prior art would never trip in mains with a current of only 100 A if the surge protection module were defective. In contrast thereto, it is provided according to the present disclosure that the tripping element may also trip directly if the surge protection module is defective, i.e., even without a surge event.

In this respect, the surge protection system according to the present disclosure ensures that an output, in particular an indicator, regarding the defective surge protection module is provided, even if no surge event is present. In other words, the defect in the surge protection module is indicated immediately, since in the event of a defect in the surge protection module, the tripping circuit is connected to the mains and is designed such that the tripping element trips.

Therefore, the surge protection system according to the present disclosure can also detect high(er)-impedance defect states of the surge protection module.

Since the tripping element is subjected to only a low current, particularly in comparison to the fuses of the prior art, operational safety is increased, as large fault currents are avoided, which cause impermissible heating and thus damage to the components of the surge protection system.

A further aspect provides that the tripping element is a (thermal) fuse, in particular a fusible element. The fuse trips under a permanent current load. For example, the fuse element melts, thereby interrupting the current path across the tripping circuit on the one hand, and driving the output, in particular the indication, of the event of a defect in the surge protection module on the other hand.

Alternatively or additionally, the surge protection module comprises a varistor and/or a spark gap. The surge protection module thus has a surge protection element, which can be designed differently depending on the field of use or application. For example, it is a (metal oxide) varistor (MOV) for Type 2 and 3 surge protection, whereas for Type 1 surge protection, a gas discharge tube or a spark gap is typically used as a surge protection element.

Furthermore, the current-limiting unit may comprise a resistor, an inductor, a semiconductor, in particular a self-conducting transistor, a voltage-switching element, and/or a voltage-switching element.

The disconnecting module may comprise a spark gap. This ensures the properties of the disconnecting module. The spark gap ensures that the disconnecting module is capable of carrying impulse currents, limits mains follow currents, and even extinguishes mains follow currents. At the same time, the spark gap ensures the voltage sustaining capability of the disconnecting module.

The surge protection system may comprise a voltage control element connected in parallel with the surge protection module, wherein the voltage control element is set up to change, in particular to reduce, the protection level of the surge protection system. The voltage control element may be a capacitor. In principle, a low protection level of the surge protection system may be achieved due to the voltage control element, which is set by the sum of the response values of the series connection of the surge protection module and the disconnecting module.

Furthermore, the tripping element may be set up to change, for example to increase the voltage sustaining capability of the disconnecting module, when the tripping element trips. The disconnecting module may have a voltage sustaining capability in its initial state, which is, however, changed, for example, increased again, in particular when the surge protection module is defective, i.e., the tripping element has tripped. Any present overvoltage is then only discharged upon reaching a different, in particular a higher, voltage value, for example starting at a voltage of 6 kV, whereas the voltage sustaining capability in the initial state is, for example, 3 kV.

With a mains voltage of 255 V, however, a voltage sustaining capability greater than 2.5 kV must be established in the disconnected state. For a mains voltage of 255 V, the surge protection module and the disconnecting module are designed, for example, to jointly ensure a protection level of 1.5 kV, i.e., a maximum voltage value of 1.5 kV. This in turn means that the voltage sustaining capability in the initial state may be less than 1.5 kV.

If higher mains voltages or other conditions are provided, the values for the voltage sustaining capability are also higher.

It may be provided that the tripping element is set up to disconnect a trigger line of the disconnecting module. This may result in a correspondingly higher voltage sustaining capability of the disconnecting module compared to the voltage sustaining capability of the disconnecting module in the initial state, that is, when there is a triggering, as the trigger line is not disconnected or interrupted.

Disconnecting the trigger line of the disconnecting module results in the disconnecting module triggering later, i.e., at a higher voltage. For this purpose, the tripping circuit may be coupled to the disconnecting module. For example, the trigger line is formed by a shunt tap of the tripping circuit, which is provided between the tripping element and the current-limiting unit, in particular downstream of the current-limiting unit. When the tripping element trips, the trigger line is then disconnected from the mains, so that the disconnecting module transitions to the surge voltage-resistant state. The disconnecting module, in particular the spark gap of the disconnecting module, then has a higher voltage sustaining capability.

However, it may also be provided that the trigger line of the disconnecting module is mechanically interrupted when the tripping element trips. In other words, a switching mechanism is activated when the tripping element trips, which causes the triggering of the disconnecting module, in particular the spark gap of the disconnecting module, to no longer be functional. This also results in the higher voltage sustaining capability of the disconnecting module.

Thus, a change in a transient state occurs when the tripping element trips. This is because the trigger line is released, e.g., disconnected from the mains or interrupted.

In principle, the surge protection system may be set up to switch from a first voltage level to a second voltage level when the tripping element trips. The switching from the first voltage level to the second voltage level may occur by releasing the trigger line when the tripping element trips.

Releasing the trigger line may result in the disconnecting module tripping later, i.e., at a higher voltage.

For example, the second voltage level prevailing after the tripping element has tripped is higher than the first voltage level. Thus, switching from the first voltage level to the second voltage level would result in an increase in voltage sustaining capability. As described above, this can be achieved by releasing the trigger line, causing the disconnecting module to trip later, i.e., at a higher voltage.

The surge protection module and the disconnecting module may be accommodated in a common housing and form a surge protection device. In this respect, the surge protection system is a single device.

Alternatively, the surge protection module and the disconnecting module are designed separately from each other, i.e., as separate devices having their own housings, such as a surge protection device and a monitoring device. The tripping circuit may be integrated into one of the two devices or may also be provided as a separate and independent device.

The disconnecting module may be designed with the tripping circuit and the output in a single device, which can be referred to as a backup protection device, in particular as an “SPD Specific Disconnector” (SSD) for the surge protection device (SPD).

Overall, a two-channel configuration may thus be achieved for the surge protection system, as a first channel and a second channel are provided.

The first channel is designed for the discharge path of surge currents and includes the disconnection module, which is capable of interrupting the maximum short-circuit current to be expected.

The second channel handles the fault current path at mains frequency and comprises the tripping circuit, in particular the tripping element and the current limiting unit.

The tripping element may have a low I2t characteristic curve.

The current limiting unit may comprise at least one impedance element. The impedance element may comprise components such as varistors (MOVs), thermistors (PTC/NTC), inductors, and/or transformers, which are connected in series or in parallel.

In the second channel, an impulse transformer may also be provided, which is in particular associated with the trigger line or present in the trigger line.

A current is discharged via the first channel in case of a surge current, e.g., a lightning strike, in that the disconnecting module transitions to a conductive state. The first channel, in particular the disconnecting module, can return to a non-conductive state after the surge current has passed, as soon as the surge protection module, in particular the surge protection element of the surge protection module, returns to a high-impedance state.

If the surge protection module, in particular the surge protection element, does not return to the high-impedance state after a surge current or in the event of other faults, the first channel, in particular the disconnecting module, remains conductive and carries the short-circuit current. The disconnecting module may include a spark gap with an arc-quenching chamber to safely interrupt even these high currents.

The second channel serves as fuse protection. Among other things, in the case of fault currents not detected by the disconnecting module, e.g., low-resistance faults without surge current, the tripping element located in the second channel intervenes and safely disconnects the protective path in which the tripping element is arranged. This may result in a change in the voltage sustaining capability of the disconnecting module.

In addition, a sensor element may be provided, which is in particular arranged in the first channel and set up to detect a short-circuit current. The sensor element thus detects the occurrence of a short-circuit current or surge current in the first channel, i.e., in the discharge path. Upon detection of such an event, a signaling may be performed and/or a protective measure may be tripped.

Furthermore, a control switch may be provided which is set up to enable or purposefully suspend monitoring for short-circuit currents at mains frequency depending on the operating state. The control switch is arranged in the second channel such that, in the open position of the control switch, no electrical connection via the second channel is possible.

In principle, the surge protection system is suitable for use in both AC and DC voltage mains.

In particular, the current limiting unit is connected upstream of the tripping element in the direction of current flow of the tripping circuit. In other words, the tripping element is arranged between the current limiting unit and the surge protection module. In particular, the trigger line of the disconnecting module terminates between the current limiting unit and the tripping element. Upon tripping of the tripping element, it is thus ensured that no current path is possible via the disconnecting module and the trigger line to the surge protection module.

### BRIEF DESCRIPTION OF THE DRAWINGS

Further advantages and features of the embodiments according to the present disclosure will become apparent from the description below and the drawings to which reference is made and in which:

FIG. 1 shows a schematic representation of a surge protection system according to an embodiment of the present disclosure,

FIG. 2 shows a schematic representation of a surge protection system according to an embodiment of the present disclosure in a first variation,

FIG. 3 shows a schematic representation of a surge protection system according to an embodiment of the present disclosure in a second variation,

FIG. 4 shows a schematic representation of a surge protection system according to an embodiment of the present disclosure in a third variation,

FIG. 5 shows a schematic representation of a surge protection system according to an embodiment of the present disclosure in a fourth variation, and

FIG. 6 shows a schematic representation of a surge protection system according to an embodiment of the present disclosure in a fifth variation.

### DETAILED DESCRIPTION

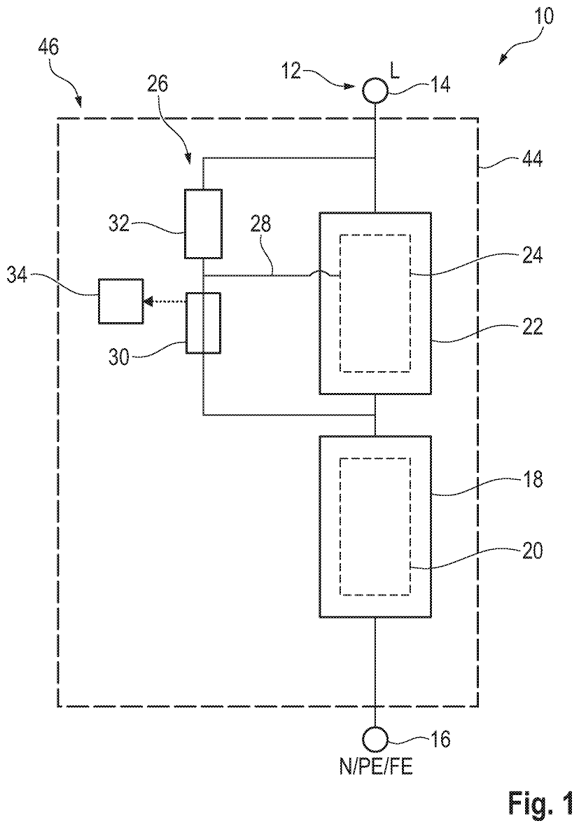

FIG. 1 shows a surge protection system 10 for surge protection or lightning protection, which is integrated into the mains 12, specifically between a first connection 14, for example a phase L, and a second connection 16, for example a neutral conductor N, protective earth PE, or functional earth FE.

The surge protection system 10 comprises a surge protection module 18, which includes a surge protection element 20, which is basically a component capable of extinguishing short-circuit currents, limiting surges, and/or switching surges. This ensures that the surge protection module 18 has a surge protection functionality to be able to discharge a surge and to at least limit, and in particular also extinguish, a mains follow current. The surge protection element 20 can be a varistor, a spark gap, or a combination of a spark gap and a varistor.

The surge protection module 18 is connected in series with a disconnecting module 22. Therefore, the surge protection module 18 and the disconnecting module 22 are arranged between the first connection 14 and the second connection 16.

The disconnecting module 22 is primarily designed to safely disconnect the surge protection module 18 from the mains 12 in the event that the surge protection module 18 is defective.

Furthermore, the disconnecting module 22 also limits mains follow currents, in particular extinguishes mains follow currents.

In general, the disconnecting module 22 can be capable of extinguishing short-circuit currents.

The disconnecting module 22 also has a voltage sustaining capability, i.e. the disconnecting module 22 is initially in a non-conducting state and only transitions to the conducting state upon reaching a defined overvoltage, e.g., at a voltage of 6 kV.

Furthermore, the disconnecting module 22 is also capable of carrying impulse currents, so that, like the surge protection module 18, it is capable of discharging a surge current, in particular a lightning surge current. To ensure the properties of the disconnecting module 22, the disconnecting module 22 comprises, for example, a spark gap 24, in particular a horn gap.

The surge protection system 10 also comprises a tripping circuit 26, which is arranged in parallel with the disconnecting module 22 such that there is a current path via the tripping circuit 26 and the surge protection module 18 between the connections 14, 16, should the surge protection module 18 be defective, as will be explained below.

In the embodiment shown, the tripping circuit 26 is connected to the disconnecting module 22 via a trigger line 28.

The tripping circuit 26 comprises a tripping element 30 and a current limiting unit 32, which are connected in series, wherein the trigger line 28 is provided as a shunt tap between the tripping element 30 and the current limiting unit 32.

The current limiting unit 32 limits a current flowing through the tripping element 30 when it flows through the current path in the event of a defect in the overvoltage protection module 18. For example, the current limiting unit 32 limits the current flowing through the tripping element 30 to less than 50 A, in particular less than 10 A.

In the embodiment shown, the tripping element 30 is a fuse element, whereas the current limiting unit 32 is formed by a (thermal) resistor. Alternatively, the current limiting unit 32 may also be formed by an inductor, a semiconductor, in particular a self-conducting transistor, a voltage-switching element, and/or a voltage-switching element.

In principle, the surge protection system 10 is set up such that a surge current or lightning surge current, also referred to as a current impulse, is discharged via the disconnecting module 22 and the surge protection module 18, for example due to a transient or temporary overvoltage. The portion of the surge current or lightning surge current which flows across the tripping circuit 26 provided in parallel with the disconnecting module 22 is negligible.

Specifically, due to the present overvoltage, both the disconnecting module 22 and the surge protection module 18 become low-impedance, so that the current flows from the first connection 14 through the series connection of the disconnecting module 22 and the surge protection module 18 to the second connection 16.

For example, the spark gap 24 of the disconnecting module 22 is ignited, causing the disconnecting module 22 to become low-impedance. The overvoltage protection element 20, i.e., the varistor and/or the spark gap, also becomes low-impedance due to the transient or temporary overvoltage.

The tripping circuit 26 and the disconnecting module 22 arranged in parallel with the tripping circuit 26 are therefore dimensioned such that the tripping element 30 does not trip in the event of such a regular discharge process of the surge current or lightning surge current. This is achieved, among other things, by the fact that the current flows only briefly.

However, if the surge protection module 18 is defective, the surge protection module 18 becomes permanently low-impedance, as a result of which the disconnecting module 22 and the tripping circuit 26 are connected to the mains 12, causing, among other things, a current to flow across the current path in which the tripping circuit 26 is located.

The current flowing through the tripping element 30 causes the tripping element 30 to trip, for example, the fuse element to melt. This may be the case within just a few milliseconds.

The tripping element 30 has a tripping characteristic curve which ensures that the tripping element 30 trips even at a current of less than 50 A, in particular at a current of less than 10 A. Thus, a surge event is not required for the tripping element 30 to trip; rather, it is sufficient for the surge protection module 18 to be defective. This allows defects in the surge protection module 18 to be detected early, including defects with higher impedance compared to prior art solutions.

When the tripping element 30 has tripped, this in turn controls an output 34, e.g., an indicator, to signal or indicate the event of a defect of the surge protection module 18 to a user.

In one embodiment, the output 34 is a visual indicator, specifically a mechanical red-green indicator, which is adjusted accordingly by a mechanical impulse originating from the tripping element 30.

In addition, the tripping element 30 changes the voltage sustaining capability of the disconnecting module 22, in particular increases the voltage sustaining capability of the disconnecting module 22.

This can be achieved by disconnecting the trigger line 28 from the disconnecting module 22 when the tripping element 30 trips or is interrupted. This results in the trigger line 28 being released.

A trigger current required for triggering to activate the disconnecting module 22, in particular to ignite the spark gap 24, must flow from the input potential of the disconnecting module 22, which is associated with the first terminal 14, to the shunt tap on the trigger line 28, and then through the tripping element 30 to the output of the disconnecting module 22. However, since the tripping element 30 has tripped, this path is blocked and the disconnecting module 22 transitions to a surge voltage-resistant state. In other words, the voltage sustaining capability of the disconnecting module 22 is increased.

The voltage sustaining capability may be 3 kV, the value being adjustable, in particular wherein the value is determined by the application site of use and corresponding altitude correction factors for the application site.

This voltage sustaining capability applies in principle to the entire disconnecting module 22, in particular the entire spark gap 24, i.e., the main electrodes of the spark gap 24 must not ignite even at this value.

However, due to the design of the disconnecting module 22, in particular the existing spark gap 24, the disconnecting module 22 nevertheless exhibits short-circuit current extinguishing capability. For example, the disconnecting module 22 becomes active during a 6 kV impulse, meaning the spark gap 24 ignites, causing a current to flow across the disconnecting module 22. The current flow can then be extinguished due to the short-circuit current extinguishing capability of the disconnecting module 22.

The surge protection system 10 can thus switch from a first voltage level to a second voltage level when the tripping element 30 trips.

In the above example, the first voltage level is 3 kV, whereas the second voltage level is 6 kV, i.e., higher than the first voltage level. As described above, however, the values can be adjusted, so they are merely illustrative.

This design is therefore clearly advantageous over conventional fuses, as tripping occurs even at low currents or in low-current mains. For example, a 250 A fuse upstream of the surge protection module 18 would never trip in mains having a current of only 100 A.

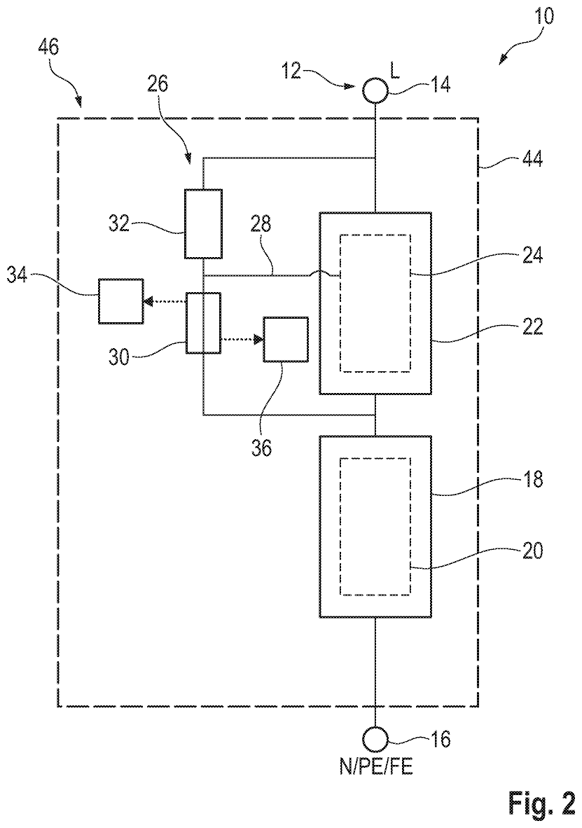

In the embodiment shown in FIG. 2, the mechanical impulse originating from the tripping element 30 is also used to actuate a functional component 36, in particular to activate a telecommunication unit to report the defect.

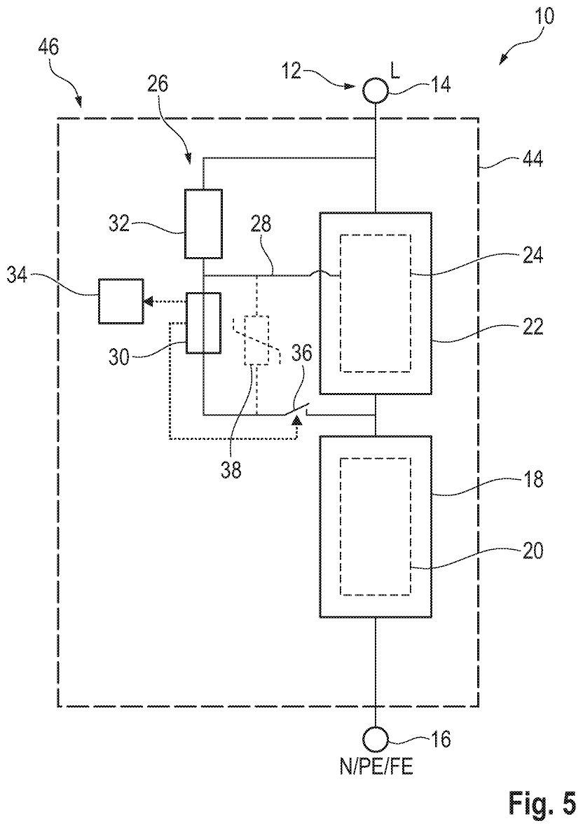

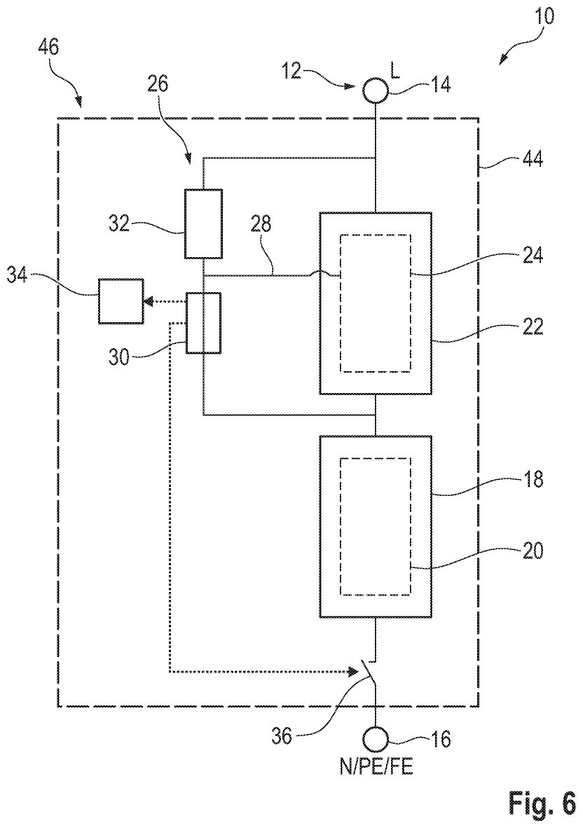

FIGS. 5 and 6 also show that the functional component 36 can be formed by a disconnecting device, which is used to disconnect the defective surge protection module 18 to protect the latter.

In FIG. 6, the functional component 36, which is set up as a disconnecting device, is arranged behind the surge protection module 18, i.e., between the surge protection module 18 and the second connection 16, so that the surge protection module 18, the disconnecting module 22, and the tripping circuit 26 are disconnected from the mains 12.

In FIG. 5, however, the functional component 36 set up as a disconnecting device is provided within the tripping circuit 26, namely in a shunt branch that terminates between the surge protection module 18 and the disconnecting module 22. This ensures voltage sustaining capability, since the functional component 36, which is designed as a disconnecting device, is actuated so that the tripping circuit 26 is disconnected from the mains 12. In this respect, this functional component 36 can also be referred to as a break contact.

The tripping element 30 provides a high ohmic resistance in the triggering. The voltage drop across the tripping element 30 can be limited by at least one voltage-limiting component 38, e.g., a varistor. In this case, the functional component 36, which acts as a disconnecting device or break contact, becomes indispensable, as the tripped tripping element 30 alone no longer allows the triggering to be interrupted.

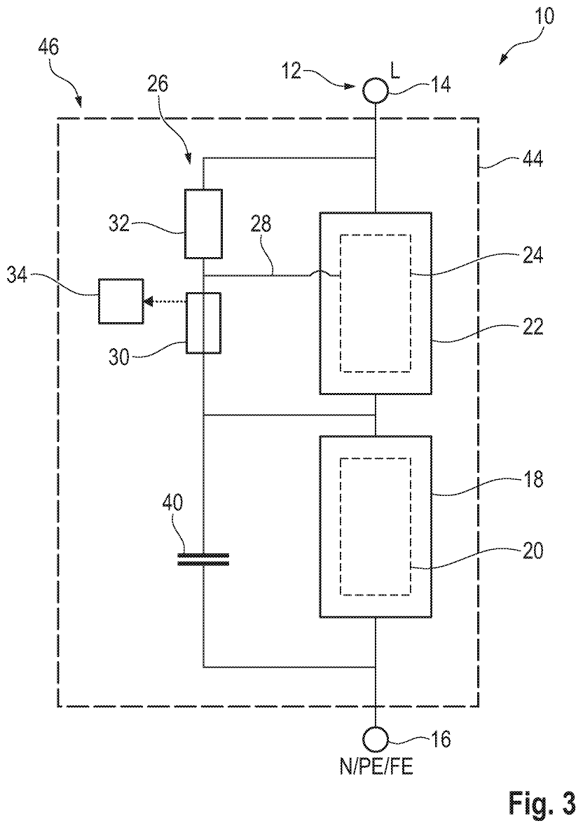

In the embodiment shown in FIG. 3, the surge protection system 10 comprises an optional voltage control element 40 connected in parallel with the surge protection module 18. The voltage control element 40 serves to change, in particular to reduce, the protection level of the surge protection system 10, which results from the sum of the response values of the series connection of the surge protection module 18 and the disconnecting module 22. For example, the voltage control element 40 is a capacitor.

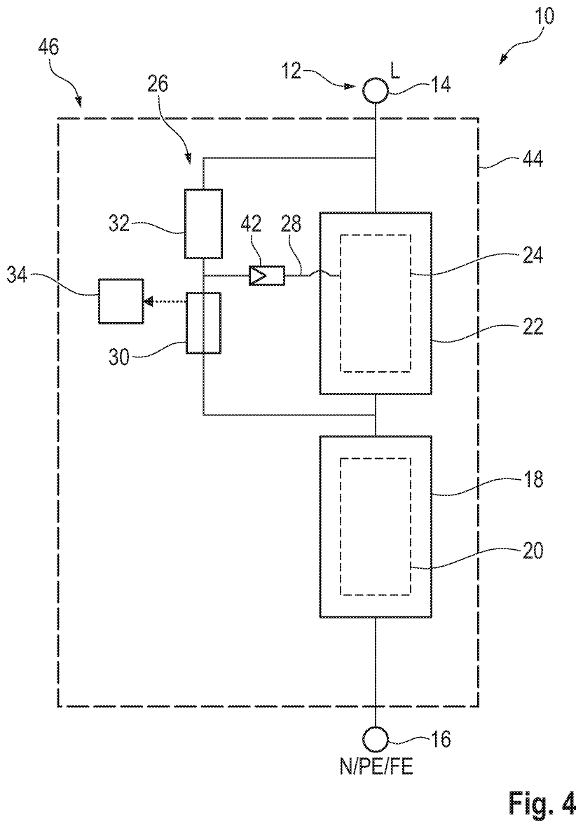

FIG. 4 shows a further embodiment in which at least one additional component 42 for adjusting the voltage sustaining capability is provided in the trigger line 28. This may be a varistor, a gas discharge tube, a diode, or another voltage-switching component. In particular, several such components 42 are also provided, for example in a series connection in the trigger line 28.

In principle, the triggering and the voltage sustaining capability can be adjusted via the at least one component 42.

The figures further show that the components of the surge protection system 10 are accommodated in a common housing 44, so that the surge protection system 10 can be formed by a single surge protection device 46.

The surge protection system 10 thus ensures that, when the surge protection module 18 is intact, a surge current or lightning surge current is discharged via the disconnecting module 22 and the surge protection module 18, whereas, if the surge protection module 18 is defective, current flows through the current path in which the tripping circuit 26 is located, so that the current trips the tripping element 30 of the tripping circuit 26, which drives the output 34, in particular the indicator, which signals or indicates the event of a defect in the surge protection module 18.

Additionally, the functional component 36 can be actuated and/or the voltage sustaining capability of the disconnecting module 22 can be increased when the tripping element 30 has tripped, in particular due to the mechanical impulse generated by the tripping of the tripping element 30.

Furthermore, the various embodiments can be combined with each other, so that the surge protection system 10, for example, can simultaneously include the component 42 for adjusting the voltage sustaining capability as well as the additional functional component 36, etc.

In principle, the surge protection system 10 shown in the preceding figures can therefore be operated such that, in the event of a defect in the surge protection module 18, there is a current path via the tripping circuit 26 and the surge protection module 18, so that, in the case of a defective surge protection module 18, a current flows through the current path, tripping the tripping element 30 of the tripping circuit 26. This activates at least the output 34, in particular the indicator, which signals or indicates the event of a defect in the surge protection module 18.

1. A surge protection system comprising a surge protection module having a surge protection functionality, and a disconnecting module connected in series with the surge protection module, wherein the disconnecting module is capable of carrying impulse currents and at least limits mains follow currents, and has a voltage sustaining capability, wherein the surge protection system comprises a tripping circuit arranged in parallel with the disconnecting module such that, in the event of a defect in the surge protection module, there is a current path via the tripping circuit and the surge protection module, wherein the tripping circuit comprises a tripping element and a current-limiting unit which limits a current flowing through the tripping element in the event of a defect in the surge protection module, and wherein the tripping element is set up to trip in the event of a defect in the surge protection module and to drive an output signaling the event of a defect in the surge protection module.

2. The surge protection system according to claim 1, wherein the tripping element is set up to mechanically drive the output.

3. The surge protection system according to claim 1, wherein the tripping element is set up to drive the output by means of a mechanical impulse.

4. The surge protection system according to claim 1, wherein the tripping element is further set up to actuate at least one functional component.

5. The surge protection system according to claim 1, wherein the at least one functional component is a disconnecting device or a telecommunication unit.

6. The surge protection system according to claim 1, wherein the tripping circuit and the disconnecting module arranged in parallel with the tripping circuit are dimensioned such that the disconnecting module and the surge protection module discharge a surge current during a discharge operation.

7. The surge protection system according to claim 1, wherein the current limiting unit limits the current flowing through the tripping element to less than 50 A, and/or in that the tripping element has a tripping characteristic which ensures that the tripping element trips at a current of less than 50 A.

8. The surge protection system according to claim 1, wherein the surge protection module comprises a varistor and/or a spark gap.

9. The surge protection system according to claim 1, wherein the disconnecting module comprises a spark gap.

10. The surge protection system according to claim 1, wherein the tripping element is a fuse.

11. The surge protection system according to claim 1, wherein the current-limiting unit comprises a resistor, an inductor, a semiconductor, a voltage-switching element, and/or a voltage-switching element.

12. The surge protection system according to claim 1, wherein the surge protection system comprises a voltage control element connected in parallel with the surge protection module, wherein the voltage control element is set up to change the protection level of the surge protection system.

13. The surge protection system according to claim 1, wherein the tripping element is set up to change the voltage sustaining capability of the disconnecting module when the tripping element trips.

14. The surge protection system according to claim 13, wherein the tripping element is set up to disconnect a trigger line of the disconnecting module.

15. The surge protection system according to claim 13, wherein the tripping element is set up to increase the voltage sustaining capability of the disconnecting module.

16. The surge protection system according to claim 1, wherein the surge protection system is set up to switch from a first voltage level to a second voltage level when the tripping element trips.

17. The surge protection system according to claim 16, wherein the second voltage level present after the tripping element has tripped is higher than the first voltage level.

18. The surge protection system according to claim 1, wherein the surge protection module and the disconnecting module are accommodated in a common housing and form a surge protection device.

19. The surge protection system according to claim 1, wherein the current limiting unit is connected upstream of the tripping element in the current flow direction of the tripping circuit.

20. A method for operating a surge protection system comprising a surge protection module having a surge protection functionality, a disconnecting module, which is capable of carrying surge currents and at least limits mains follow currents, and has a voltage sustaining capability, wherein the disconnecting module is connected in series with the surge protection module, wherein, when the surge protection module is intact, a surge current is discharged via the disconnecting module and the surge protection module, and wherein the surge protection system comprises a tripping circuit arranged in parallel with the disconnecting module such that, in the event of a defect in the surge protection module, there is a current path via the tripping circuit and the surge protection module, so that in the event of a defective surge protection module, a current flows through the current path, which trips a tripping element of the tripping circuit, thereby activating an output which signals the event of a defect in the surge protection module.
